(19) United States
(12) Patent Application Publication
(10) Pub. No.: US 2013/0268159 A1
(43) Pub. Date: Oct. 10, 2013

(54) ENERGY GENERATION CONTROLLER

(71) Applicant: DENSO CORPORATION, Kariya-city (JP)

(72) Inventor: Mitsuhiro KANAYAMA, Takahama-city (JP)

(73) Assignee: Denso Corporation, Kariya-city (JP)

(21) Appl. No.: 13/856,735

(22) Filed: Apr. 4, 2013

(30) Foreign Application Priority Data
Apr. 4, 2012 (JP) 2012-85678

(51) Int. Cl. G06F 17/00

(52) U.S. Cl. CPC G06F 17/00
USPC 701/36

(57) ABSTRACT

An energy generation controller for a vehicle includes: an internal combustion engine; an energy generating device for converting a driving force of the engine to a predetermined type of energy, an energy generating amount being controlled by a control signal; an energy storage device for storing the predetermined type of energy; an output device for determining and outputting the control signal for generating a target energy amount of the energy generating device when the internal combustion engine is in a predetermined operating state; a detector for detecting an energy accumulation amount stored in the energy storage device; a comparison device for comparing the energy accumulation amount with an assumption accumulation amount estimated by the control signal; and an adjustment device for adjusting the control signal according to a comparison result of the comparison device.

### CROSS REFERENCE TO RELATED APPLICATION

This application is based on Japanese Patent Application No. 2012-85678 filed on Apr. 4, 2012, the disclosure of which is incorporated herein by reference.

### TECHNICAL FIELD

The present disclosure relates to an energy generation controller for controlling an energy generator, which is driven by an internal combustion engine.

### BACKGROUND

For example, JP-A-2010-259152 teaches a technique such that an alternator generates electricity so that a battery is charged when an internal combustion engine is in a certain operating condition that fuel consumption is low, i.e., the fuel consumption is good. Thus, the fuel consumption for charging the battery is reduced.

In the above technique, the alternator switches between generating the electricity and interrupting to generate the electricity, according to the operating condition of the internal combustion engine and the charging condition of the battery.

Accordingly, when the charging amount in the battery per unit time is smaller than an estimation value because of the variation of the characteristics of the alternator and/or the battery and the change of the characteristics caused by deterioration, it is difficult to accumulate the electricity (i.e., the electric energy) in the battery as expected even if the internal combustion engine is in the certain operating condition that the fuel consumption is low. Thus, it is necessary to generate the electricity using the alternator in order to charge the battery even though the engine is in an operation condition that the fuel consumption is larger than the certain operating condition. Thus, the fuel consumption increases, i.e., the fuel consumption for storing the energy in the battery as an energy storage device increases.

### SUMMARY

It is an object of the present disclosure to provide an energy generation controller for controlling an energy generating device, which is driven by an internal combustion engine, in order to reduce energy consumption for storing energy in an energy storage device.

According to an aspect of the present disclosure, an energy generation controller for a vehicle includes: an internal combustion engine of the vehicle; an energy generating device driven by the internal combustion engine for converting a driving force of the internal combustion engine to a predetermined type of energy, an energy generating amount of the energy generating device being controlled by a control signal; an energy storage device for storing a whole of or a part of the predetermined type of energy, which is generated at the energy generating device; an output device for determining the control signal for generating a target energy amount of the energy generating device when the internal combustion engine is in a predetermined operating state, and for outputting the control signal to the energy generating device; a detector for detecting an energy accumulation amount stored in the energy storage device; a comparison device for comparing the energy accumulation amount detected by the detector with an assumption accumulation amount, which is estimated by the control signal determined by the output device; and an adjustment device for adjusting the control signal to be output to the energy generating device according to a comparison result of the comparison device.

In the above controller, when the comparison device determines the comparison result that the assumption accumulation amount is larger than the actual energy accumulation amount, the adjustment device adjusts the control signal in order to increase the energy generating amount to be generated by the energy generating device. Accordingly, in a case where the internal combustion engine is in the predetermined operating state, even if the characteristic variation and/or the deterioration of the energy generating device and the energy accumulation device cause the characteristic change of the energy generating device and the energy accumulation device so that the actual energy accumulation amount becomes smaller than the assumption accumulation amount, the adjustment device adjusts the control signal to increase the energy generating amount in order to store the assumption accumulation amount in the energy storage device. Thus, when the internal combustion engine is in a state having a fuel consumption ratio higher than the predetermined operating state, the controller avoids generating the energy at the energy generating device and storing the energy in the energy storage device. Alternatively, the controller reduces the number of occurrences of a situation that it is necessary to generate the energy at the energy generating device in order to store the energy in the energy storage device. Thus, the controller restricts the fuel consumption increase for storing the energy in the energy storage device.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing an electric control unit (i.e., ECU) together with peripheral devices according to a first embodiment;

FIG. 2 is a graph showing a fuel consumption rate in accordance with the number of rotations and an output torque of the engine;

FIG. 3 is a flowchart showing a fundamental control process;

FIG. 4 is a flowchart showing an adjustment process;

FIG. 5 is a graph showing an operation of the ECU according to the first embodiment;

FIG. 6 is a block diagram showing an ECU together with peripheral devices according to a second embodiment; and

FIG. 7 is a flowchart showing a mutual adjustment process.

### DETAILED DESCRIPTION

An electric control unit (ECU) as an energy generation controller will be described.

### First Embodiment

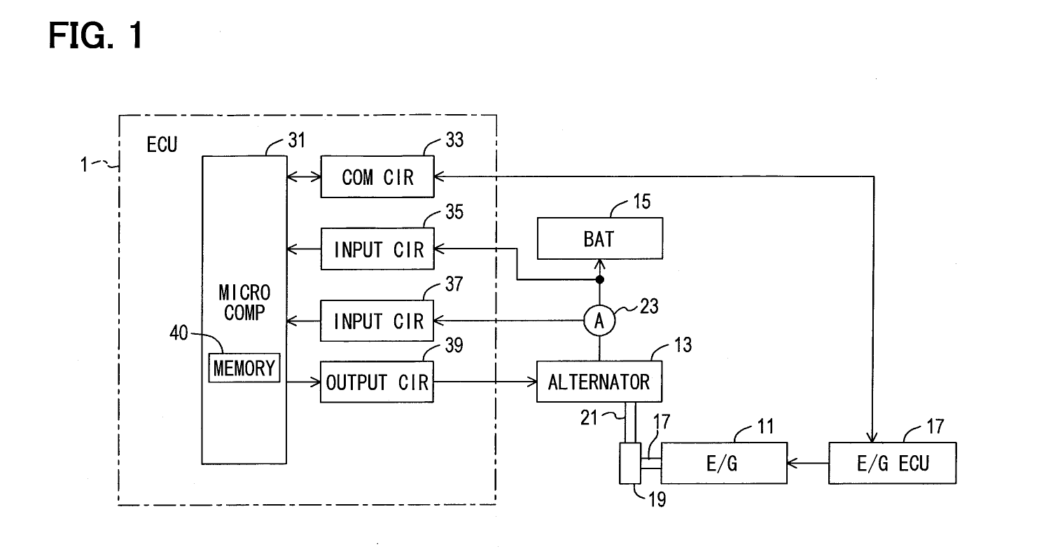

As shown in FIG. 1, a vehicle, on which the ECU 1 according to the present embodiment is mounted, includes an engine 11 as an internal combustion engine, which is a power source of the vehicle, an alternator 13 for generating electricity driven by the engine 11, a battery 15 charged by the alternator 13, and an engine electric control unit (i.e., engine ECU) 17 for controlling the engine 11.

The output power of the engine 11 is transmitted to the alternator 13 as a driving force of the alternator 13 via a pulley 19 and a belt 21. The pulley 19 is rotated by a crank shaft 17 of the engine 11. The belt 21 is placed on the pulley 19. Thus, the output power of the engine 11 is transmitted to the alternator 13 as the driving force. The alternator 13 converts the driving force from the engine 11 to an electric energy, which is different from the driving force. A part of the electric energy generated by the alternator 13 is consumed in an electric load mounted on the vehicle. The other of the electric energy is accumulated (i.e., charged) in the battery 15.

On an electric path as a charging passage from the alternator 13 to the battery 15, a current meter 23 for measuring the current flowing into and outputting from the battery 15.

The ECU 1 includes at least a micro computer 31 for executing a process of controlling the alternator 13, a communication circuit 33 for communicating between the micro computer 31 and the engine ECU 17, an input circuit 35 for inputting a voltage of the battery 15 (i.e., a battery voltage) into the micro computer 31, an input circuit 37 for inputting an output signal from the current meter 23 (i.e., a detection result of the current meter 23) into the micro computer 31, and an output circuit 39 for supplying a control signal to the alternator 13. The control signal for controlling the alternator 13 is output from the micro computer 31.

In the present embodiment, the control signal to the alternator 13 is, for example, a PWM (pulse width modulated signal). The output current from the alternator 13 is constant, i.e., a rated value. The output voltage varies in accordance with a duty ratio of the PWM signal as the control signal. Thus, the generating amount of electric energy also varies.

Here, both of the output voltage and the output current from the alternator 13 may be controller by the control signal. In this case, a first control signal for instructing, i.e., controlling the output voltage and a second control signal for instructing the output current are input from the micro computer 31 to the alternator 13.

The micro computer 31 includes a non-volatile memory 40 such as a flash memory or a EEPROM, which is capable of rewriting data, in addition to a conventional CPU, a ROM and a RAM (not shown).

A process for controlling the alternator 13 using the micro computer 31 will be described. In the present embodiment, an operating condition of the engine 11 is classified into multiple operating states, which includes a first operating state to a N-th operating state. Here, N represents a natural number larger than two. An order from the first to the N-th operating states is an increasing order of the fuel consumption rate.

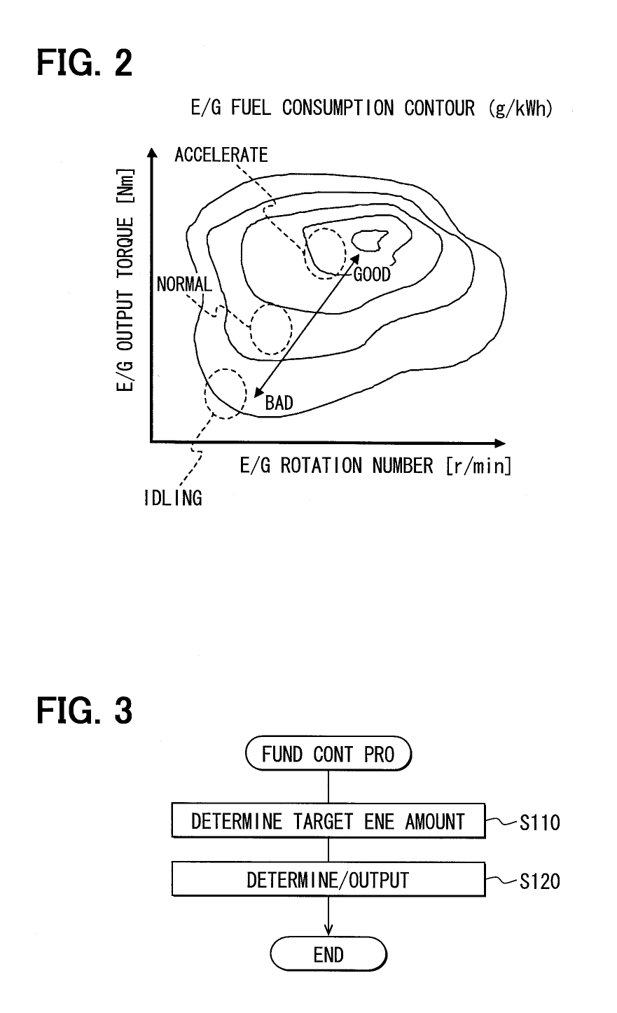

The fuel consumption rate is defined as a fuel consumption amount for generating unit energy per unit time. A solid curve in FIG. 2 represents a constant fuel consumption curve showing a certain constant fuel consumption rate. Here, the constant fuel consumption curve is a contour of the fuel consumption rate. The horizontal axis in FIG. 2 represents the number of rotations of the engine 11, i.e., the engine rotation speed. The vertical axis in

FIG. 2 represents a torque, i.e., the engine output torque, which is generated by the engine 11. In FIG. 2, as the number of rotations of the engine 11 in the operating condition increases, or as the torque of the engine increases, i.e., as the region in FIG. 2 reaches a right upper corner, the fuel consumption rate is reduced (i.e., the fuel consumption is improved). The fuel consumption rate increases in the order of the acceleration state, the normal state and the idling state, i.e., the fuel consumption rate gets worse in the order of the acceleration state, the normal state and the idling state. When a driver of the vehicle does not push an acceleration pedal, and the engine rotation number is equal to or larger than a predetermined value such as 2000 r/min, a fuel supply cut process is executed so that the fuel injection to the engine is interrupted. In this fuel supply cut state, the fuel consumption rate becomes zero.

Thus, in the present embodiment, for example, the fuel supply cut state is referred as a first operating state. When the engine rotation number and the engine output torque are in a range corresponding to the acceleration state, the operating state of the engine is referred as a second operating state. When the engine rotation number and the engine output torque are in a range corresponding to the normal state, the operating state of the engine is referred as a third operating state. When the engine rotation number and the engine output torque are in a range corresponding to the idling state, the operating state of the engine is referred as a fourth operating state. In this case, the natural number of N is four.

The micro computer 31 determines the operating state of the engine 11 among the first to fourth operating states, according to the information, which is obtained from the engine ECU 17, and includes the information indicative of execution of the fuel supply cut process and the information indicative of the engine rotation number and the engine output torque.

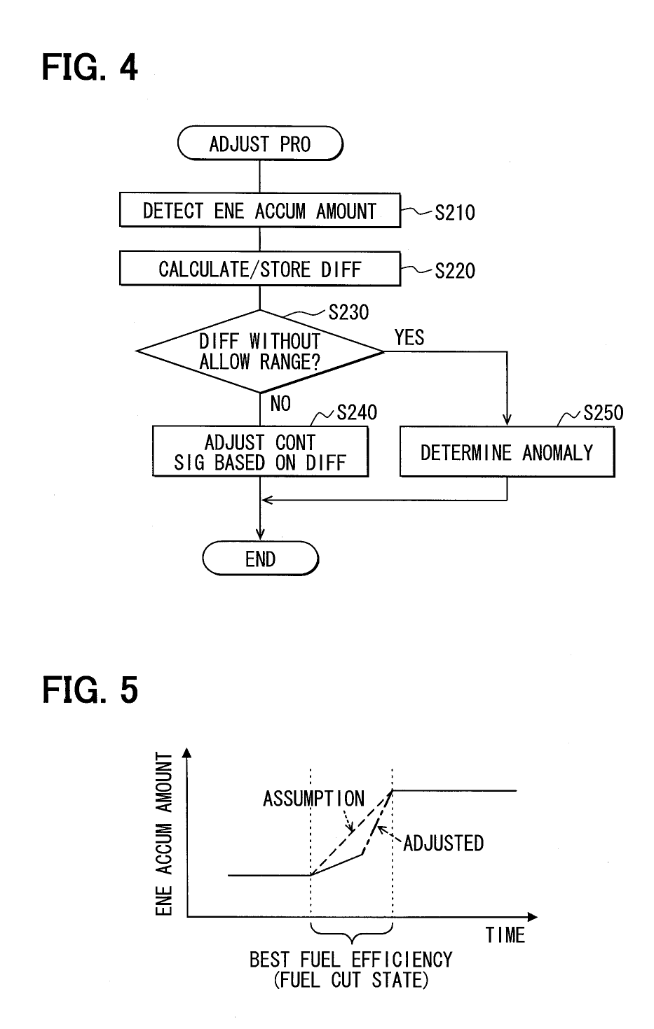

Further, the micro computer 31 executes the fundamental control process in FIG. 3 and the adjustment process in FIG. 4 at each operating state with regard to the alternator 13 and the battery 15. Here, in the present embodiment, the micro computer 31 executes the fundamental control process in FIG. 3 and the adjustment process in FIG. 4 ever time the operating state of the engine 11 changes from one state to another state among the first to N-th operating states.

As shown in FIG. 3, when the micro computer 31 starts to execute the fundamental control process, at step S110, a target energy generating amount as a target value of energy, which is generated by the alternator 13 per unit time, is determined. In the present embodiment, since the output voltage of the alternator 13 is controllable, the target energy generating amount is specified by the target output voltage of the alternator 13.

Specifically, the ROM in the micro computer 31 stores a map, in which the target output voltage at each operating state of the engine 11 is recorded. According to the map, the target output voltage is determined in accordance with the current operating state of the engine 11. In the map, as the fuel consumption rate provided by the operating state is reduced, the target output voltage corresponding to the operating state increases. Thus, the fuel consumption rate is reversely proportion to the target output voltage. When the fuel consumption rate in the operating state is reduced, the output voltage of the alternator 13 becomes large so that the target energy generating amount is large. Thus, the charging amount to the battery 15 becomes large.

Here, in accordance with the charging degree of the battery 15, the target output voltage may be changed. In this case, the map registers the target output voltage, which depends on two parameters of the operating state of the engine 11 and the charging degree of the battery 15. The micro computer 31 may determine the target output voltage in accordance with the operating state of the engine 11 and the charging degree of the battery 15 with reference to the map.

Next, at step S120, the micro computer 31 determines the control signal corresponding to the target output voltage determined in step S110. The control signal provides to control the output voltage of the alternator 13 to reach the target output voltage. In the present embodiment, the micro computer 31 determines a duty ratio, which is defined by the control signal. Then, the micro computer 31 controls the output circuit 39 to output the control signal to the alternator 13.

After the micro computer 31 performs the process in step S120, the computer 31 ends the fundamental control process. Then, the computer 31 starts to execute an adjustment process shown in FIG. 4 after predetermined time T has elapsed since the fundamental control process is completed.

As shown in FIG. 4, when the micro computer 31 starts to execute the adjustment process, at step S210, the computer 31 detects the energy accumulation amount Q1, which has been accumulated in the battery 15 until the present time since the computer 31 completes the fundamental control process in FIG. 3. Here, the time interval until the present time since the computer 31 completes the fundamental control process corresponds to the predetermined time T, and the energy accumulation amount Q1 is an electric energy, which defines a charge amount. Specifically, the micro computer 31 calculates the accumulation amount as the charge amount Q1 to the battery 15 according to the battery voltage and the charge current to the battery 15 during the predetermined time interval T. Here, the charge current to the battery 15 is detected by an output signal of the current meter 23.

Next, in step S220, the micro computer 31 compares an assumption accumulation amount (i.e., an assumption charge amount) Q2, which is an energy accumulation amount of the battery 15 calculated according to the control signal determined in step S120, and the actual accumulation amount Q1 detected in step S210. In the present embodiment, the computer 31 calculates a difference Δ between the assumption accumulation amount Q2 and the actual accumulation amount Q1 as a comparison result. Here, the difference Δ is calculated by the equation of Δ=Q2−Q1. Further, in step S220, the computer 31 controls the memory 40 to store the calculated difference Δ, which corresponds to one of the first to N-th operating states, such that a correspondence relationship between the difference Δ and the one of the first to N-th operating states is distinguishably stored.

Here, the assumption accumulation amount Q2 is calculated by subtracting an energy amount (i.e., an electric energy) Q4 consumed at the electric load on the vehicle from an assumption energy amount Q3 generated by the alternator 13 during the predetermined time interval T since the fundamental control process is completed. For example, the assumption energy amount Q3 is calculated by multiplying the target output voltage determined in step S110, the output current of the alternator 13 and the predetermined time interval T. The energy amount Q4 consumed at the electric lad is calculated by the current detected by another current meter (not shown) disposed on a current path to the electric load and the battery voltage. Here, the current detected by another current meter is consumed current at the electric load. When all of energy generated by the alternator 13 is accumulated in the battery 15, the assumption energy amount Q3 is equal to the assumption accumulation amount Q2.

At step S230, the micro computer 31 determines whether the difference A calculated in step S220 is disposed within an allowable range, which provides a normal range. When the difference Δ is disposed within the allowable range, it goes to step S240. In step S240, the computer 31 adjusts the control signal to the alternator 13 in accordance with the difference Δ calculated in step S220.

Specifically, when the difference Δ is positive, the assumption accumulation amount Q2 is larger than the actual accumulation amount Q1, i.e., “Q2>Q1.” In this case, the duty ratio of the control signal is made larger than the duty ratio of the control signal corresponding to the target output voltage determined in step S120, so that the energy amount generated by the alternator 13 increases. Here, the larger the difference Δ is, the larger the duty ratio of the control signal is set. On the other hand, when the difference Δ is negative, the assumption accumulation amount Q2 is smaller than the actual accumulation amount Q1, i.e., “Q2<Q1.” In this case, the duty ratio of the control signal is made smaller than the duty ratio of the control signal corresponding to the target output voltage determined in step S120, so that the energy amount generated by the alternator 13 decreases. Here, the larger the absolute value of the difference Δ is, the smaller the duty ratio of the control signal is set.

After the micro computer 31 executes step S240, the computer 31 completes the adjustment process.

When the micro computer 31 determines that the difference Δ is not disposed within the allowance range, i.e., when the difference Δ exceeds the allowance range, it goes to step S250. In step S250, the computer 31 determines that the anomaly occurs at the alternator 13 or the battery 15. Here, in this case, the alternator 13 does not generate the energy normally, or the battery does not store the energy normally. Further, in step S250, for example, the computer 31 may control the alternator 13 to stop operation, or the computer 31 may control the alternator 13 to restrict the working load of the alternator 13, i.e., the electric energy generated by the alternator 13. Alternatively, the computer 31 may execute a process for setting a flag indicative of the occurrence of the anomaly. Thus, the computer 31 executes anomaly process. Then, the computer completes the adjustment process.

Assuming that the computer 31 has been executed the adjustment process once with respect to one of the first to N-th operating states, the memory 40 stores the difference Δ corresponding to the one of the first to N-th operating states. Here, the one of the first to N-th operating states is referred as the M-th operating state. In this case, when the operating state of the engine 11 becomes the M-th operating state again, the micro computer 31 does not perform steps S210 and S220 in the adjustment process. Instead, the computer may execute steps S230 and S240 with using the difference Δ stored in the memory 40. Specifically, the difference Δ correspond to the M-th operating state.

Thus, the ECU 1 calculates the difference Δ as the comparison result between the actual accumulation amount Q1 and the assumption accumulation amount Q2 of the energy in the battery 15, which is assumed and estimated according to the control signal determined in step S120 (i.e., the fundamental value of the control signal). Further, the ECU 1 adjusts the control signal to the alternator 13 in accordance with the difference Δ in step S240. Accordingly, even when the characteristic variation and/or the deterioration of the alternator 13 as the energy generating device and the battery 15 as the energy accumulation device cause the characteristic change of the alternator 13 and the battery 15, so that the actual accumulation amount Q1 in the battery 15 becomes smaller than the assumption accumulation amount Q2, the control signal is adjusted so that the energy generation amount of the alternator 13 increases. Thus, the energy accumulation amount of the battery 15 increases, so that the battery 15 can accumulate the assumption accumulation amount Q2.

For example, as shown in FIG. 5, when the operating state of the engine 11 is a fuel cut state, which provides the best fuel efficiency, the energy accumulation amount in the battery 15 can be controlled to a predetermined assumption value. Thus, when the fuel consumption ratio of the engine 11 is small, the battery 15 can be charged according to the assumption. Therefore, when the engine 11 is in the operating state, in which the fuel consumption ratio is large, for example, when the engine is in the second or third operating state, of which the fuel consumption ratio is larger than the fuel cut state, the ECU 1 avoids a situation that it is necessary to generate the electricity at the alternator 13 in order to charge the battery 15. Alternatively, the ECU 1 reduces the number of occurrences of the situation that it is necessary to generate the electricity at the alternator 13 in order to charge the battery 15. Thus, the ECU 1 restricts the fuel consumption increase for charging the energy in the battery 15.

The ECU 1 executes the processes in FIGS. 3 and 4 at each operating state of the engine 11. Further, the ECU 1 stores the difference Δ corresponding to each operating state in the memory 40. Thus, as described above, it is not necessary to calculate the difference Δ when the operating state is same. Instead, the ECU 1 utilizes the difference Δ in the memory 40. Thus, the processing load of the micro computer 31 is reduced.

Further, when the ECU 1 determines in step S230 that the difference Δ exceeds the allowance range, the ECU 1 determines that the anomaly occurs. Thus, when the anomaly occurs at the alternator 13 or the battery 15, the ECU 1 detects the anomaly.

Here, in the present embodiment, each of the first to N-th operating states corresponds to an example of a specific operating state.

### Second Embodiment

Next, a second embodiment will be described.

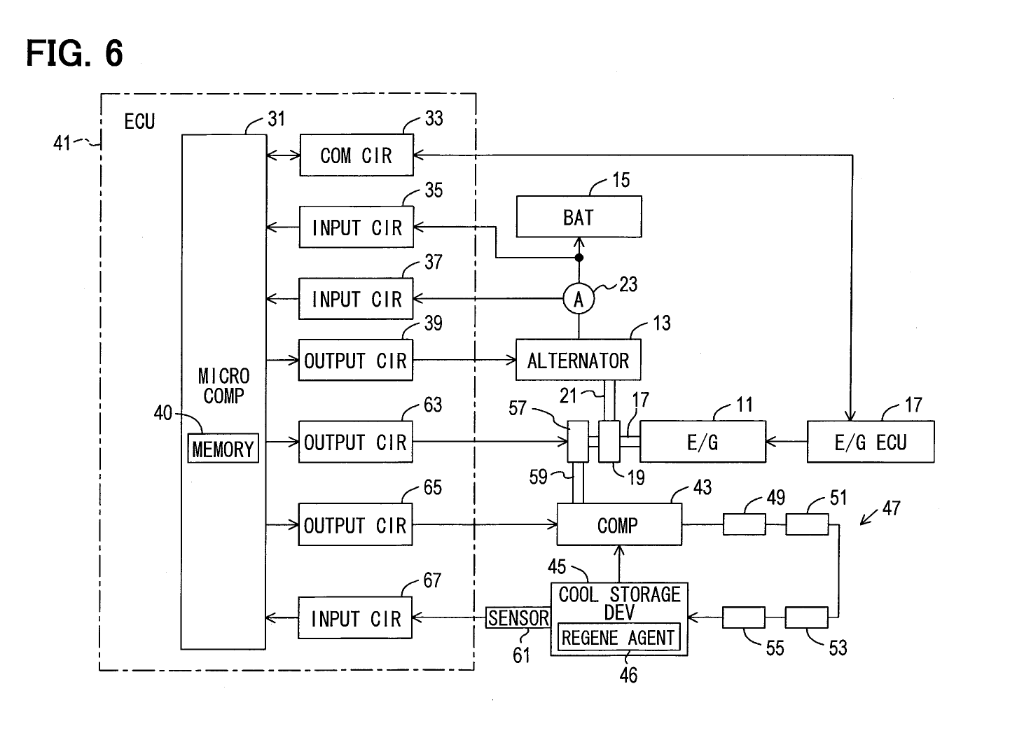

As shown in FIG. 6, a vehicle mounting an ECU 41 according to the second embodiment thereon includes the engine 11 and a refrigerating system 47 having a compressor 43 driven by the engine 11 and a cooling storage device 45.

The refrigerating system 47 includes the compressor 43, a condenser 49, a receiver tank 51, an expansion valve 53, an evaporator 55 and the cooling storage device 45, which are connected with each other via a coolant pipe so that the coolant circulates a path from a discharge port of the compressor 43 to a suction port of the compressor 43 through the condenser 49, the receiver tank 51, the expansion valve 43, the evaporator 55, and the cooling storage device 45.

In the refrigerating system 47, the coolant is compressed at the compressor 43 so that the temperature of the coolant increases. Then, the high temperature coolant is transmitted to the condenser 49. At the condenser 49, the heat of the coolant is discharged and condensed, so that the coolant is liquefied. Then, the liquid coolant is transmitted to the expansion valve 53 via the receiver tank 51. At the expansion valve 53, the coolant is expanded from a liquid state to a mist state, in which the temperature and the pressure of the coolant are low. Then, the coolant is transmitted to the evaporator 55. At the evaporator 55, the coolant is evaporated so that the coolant is vaporized. Thus, the evaporator 55 is cooled by evaporative latent heat. Accordingly, air flow along the evaporator 55 is cooled, and then, the cooled air is blown into a compartment of the vehicle. The coolant vaporized at the evaporator 55 is transmitted to the cooling storage device 45 from the evaporator 55. Further, the coolant is suctioned by the compressor 43. Then, the coolant is compressed at the compressor 43. Then, the compressed coolant is transmitted to the condenser 49. Thus, the above refrigerant cycle is repeated.

The compressor 43 is connected to a crank shaft 17 of the engine 11 via an electromagnetic clutch 57 and a belt 59. The electromagnetic clutch 57 is engaged by a driving signal from the ECU 41. Accordingly, when the engine 11 is running, and the ECU 41 inputs the driving signal to the electromagnetic clutch 57 so that the electromagnetic clutch 57 is engaged, the output power of the engine 11 is transmitted to the compressor 43 as a driving force. The compressor 43 is driven by the engine 11, so that the driving force of the engine 11 is converted to cold energy, which is different from the driving force.

The capacity of the compressor 43 is varied in accordance with the control signal from the ECU 41. Here, the control signal is, for example, a voltage signal or a PWM signal. Thus, the compressor 43 is a variable capacity type compressor. Accordingly, when the control signal is input from the ECU 41 to the compressor 43, the cold energy amount, i.e., an amount of cold energy generated at the compressor 43 is also changed.

The regenerating agent 46 is disposed in the cooling storage device 45. When the compressor 43 is in operation, and the coolant discharged from the evaporator 55 flows in the cooling storage device 45. Thus, the coolant exchanges heat with the regenerating agent 46, and the cold energy of the coolant is stored in the regenerating agent 46. In the cooling storage device 45, the coolant exchanges heat with the regenerating agent 46, so that the temperature of the coolant increases. Then, the coolant having high temperature flows out of the cooling storage device 45, and flows into the compressor 43. Accordingly, a whole of or a part of the cold energy generated at the compressor 43 is stored in the cooling storage device 45, specifically in the regenerating agent 46.

Further, the cooling storage device 45 includes a temperature sensor 61 for detecting the temperature of the cooling storage device 46.

The ECU 41 further includes: an output circuit 63 for outputting the driving signal to the electromagnetic clutch 57 in accordance with an instruction of the micro computer 31; an output circuit 65 for outputting the control signal from the computer 31 to the compressor 43; and an input circuit 67 for inputting an output signal of the temperature sensor 61 into the micro computer 31. Here, the output signal of the temperature sensor 61 corresponds to the detection result of the temperature of the regenerating agent 46.

In the above ECU 41, the micro computer 31 controls the electromagnetic clutch 57 to engage so that the compressor 43 functions when a condition for operating the compressor 43 is satisfied. Further, in this case, the computer 31 executes the fundamental control process in FIG. 3 and the adjustment process in FIG. 4 at each operating state of the engine 11 with respect to the compressor 43 and the cooling storage device 45.

Next, the fundamental control process in FIG. 3 and the adjustment process in FIG. 4 executed with respect to the compressor 43 and the cooling storage device 45 will be described.

In step S110 of the fundamental control process in FIG. 3, the computer 31 determines a target generation amount (i.e., a target cold energy generating amount) as the target amount of energy, which is generated at the compressor 43 per unit time.

Specifically, the ROM of the micro computer 31 stores a map, in which the target cold energy generating amount at each operating state of the engine 11 is registered. Based on the map, the computer 31 determines the target cold energy generating amount in accordance with the current operating state of the engine 11. In the map, as the fuel consumption ratio in the operating state is small, the target cold energy generating amount becomes large. Thus, the smaller the fuel consumption ratio in the operating state is, the larger the cold energy generated by the compressor 43 is. Thus, the cold energy amount (i.e., the storage cold energy amount) stored in the cooling storage device 45 increases.

Here, the target cold energy generating amount may be changed in accordance with the storage cold energy amount in the cooling storage device 45. Here, the concrete parameter of the storage cold energy amount in the cooling storage device 45 is, for example, temperature of the regenerating agent 46. In this case, the map registers the target cold energy generating amount in accordance with two parameters, which are the operating state of the engine 11 and the storage cold energy amount. Based on the map, the computer 31 determines the target cold energy generating amount in accordance with the current operating state of the engine 11 and the current storage cold energy amount.

In step S120 of the fundamental control process in FIG. 3, the computer 31 determines the control signal corresponding to the target cold energy generating amount, which is determined in step S110. Here, the control signal is an instruction for generating the target cold energy generating amount at the compressor 43. The determined control signal is input from the output circuit 65 to the compressor 43.

After the computer 31 performs step S120, the computer 31 ends the fundamental control process. Then, when the predetermined time T has elapsed since the fundamental control process is terminated, the computer 31 executes the adjustment process in FIG. 4.

In step S210 of the adjustment process in FIG. 4, the computer 31 detects the energy storage amount (i.e., the accumulated cold energy amount) q1 stored in the cooling storage device 45 during the predetermined time interval T since the fundamental control process is completed, i.e., until the present time after the fundamental control process is completed. Specifically, the computer 31 calculates the actual storage amount (i.e., actual storage cold energy amount) q1 in the cooling storage device 45 according to the temperature change of the regenerating agent 46 during the predetermine time interval T.

In step S220, the computer 31 compares the assumption storage amount (assumption storage cold energy amount) q2 as the energy accumulation amount in the cooling storage device 45 with the actual storage amount q1. Here, the assumption storage amount q2 is estimated according to the control signal determined in step 5120. Specifically, the computer 31 calculates a difference Δ between the assumption storage amount q2 and the actual storage amount q1 as a comparison result. Here, the difference Δ is calculated by the equation of Δ=q2−q1. Further, in step S220, the computer 31 controls the memory 40 to store the calculated difference Δ, which corresponds to one of the first to N-th operating states, such that a correspondence relationship between the difference Δ and the one of the first to N-th operating states is distinguishably stored.

Here, the assumption storage amount q2 is calculated by subtracting an energy amount (i.e., an cold energy) q4 consumed at the evaporator 55 in order to cool the compartment of the vehicle from an assumption energy amount q3 generated by the compressor 43 during the predetermined time interval T since the fundamental control process is completed. For example, the assumption energy amount q3 is calculated by multiplying the target cold energy generating amount determined in step S110 and the predetermined time interval T The energy amount q4 consumed at the evaporator 55 for cooling the compartment of the vehicle is calculated by the outside temperature of the vehicle, the number of rotations of a blower fan for blowing air into the compartment and the like. Here, when all of the cold energy generated at the compressor 43 is stored in the cooling storage device 45, for example, when the blower fan stops operating, the assumption energy amount q3 is equal to the assumption storage amount q2.

At step S230, the micro computer 31 determines whether the difference A calculated in step S220 is disposed within an allowable range, which provides a normal range. When the difference Δ is disposed within the allowable range, it goes to step S240. In step S240, the computer 31 adjusts the control signal to the alternator 13 in accordance with the difference Δ calculated in step S220.

Specifically, assuming that the control signal to the compressor 43 is a voltage signal, when the difference Δ is positive, the assumption storage amount q2 is larger than the actual storage amount q1, i.e., “q2>q1.” In this case, the voltage of the control signal is made larger than the control signal determined in step S120, so that the capacity of the compressor 43 increases. Thus, the energy amount (i.e., the cold energy amount) generated at the compressor 43 increases. Here, the larger the difference Δ is, the larger the voltage of the control signal is set. On the other hand, when the difference Δ is negative, the assumption storage amount q2 is smaller than the actual storage amount q1, i.e., “q2<q1.” In this case, the voltage of the control signal is made smaller than the control signal determined in step S120, so that the energy amount generated by the compressor 43 decreases. Here, the larger the absolute value of the difference Δ is, the smaller the voltage of the control signal is set. When the control signal is, for example, a PWM signal, instead of the voltage, the duty ratio is controlled to be larger or smaller.

After the micro computer 31 executes step 5240, the computer 31 completes the adjustment process.

When the micro computer 31 determines that the difference Δ is not disposed within the allowance range, i.e., when the difference Δ exceeds the allowance range, it goes to step S250. In step S250, the computer 31 determines that the anomaly occurs at the compressor 43 or the cooling storage device 45. Here, in this case, the compressor 43 does not generate the energy normally, or the cooling storage device 45 does not store the energy normally. Further, in step S250, for example, the computer 31 may control the compressor 43 to stop operation, or the computer 31 may control the compressor 43 to restrict the working load of the compressor 43, i.e., the cold energy generated by the compressor 43. Alternatively, the computer 31 may execute a process for setting a flag indicative of the occurrence of the anomaly. Thus, the computer 31 executes anomaly process. Then, the computer 31 completes the adjustment process.

In the ECU 41 according to the second embodiment, the effects with respect to the compressor 43 and the cooling storage device 45 are obtained similar to the effects of the alternator 13 and the battery 15, which are described in the first embodiment.

When the micro computer 31 of the ECU 41 adjusts the control signal to the alternator 13 in step S240, the computer 31 also adjusts the control signal to the compressor 43 in accordance with the adjusted result for the alternator 13 in step S240. When the micro computer 31 of the ECU 41 adjusts the control signal to the compressor 43 in step S240, the computer 31 also adjusts the control signal to the alternator 13 in accordance with the adjusted result for the compressor 43 in step S240.

Here, a mutual adjustment process for mutually adjusting the alternator 13 and the compressor 43 executed by the computer 31 will be described. Here, one of the alternator 13 and the compressor 43 is referred as a first energy generating device, and the other is referred as a second energy generating device. Further, one of the battery 15 and the cooling storage device 45 is referred as a first energy storage device for accumulating the energy generated at the first energy generating device, and the other is referred as a second energy storage device for accumulating the energy generated at the second energy generating device.

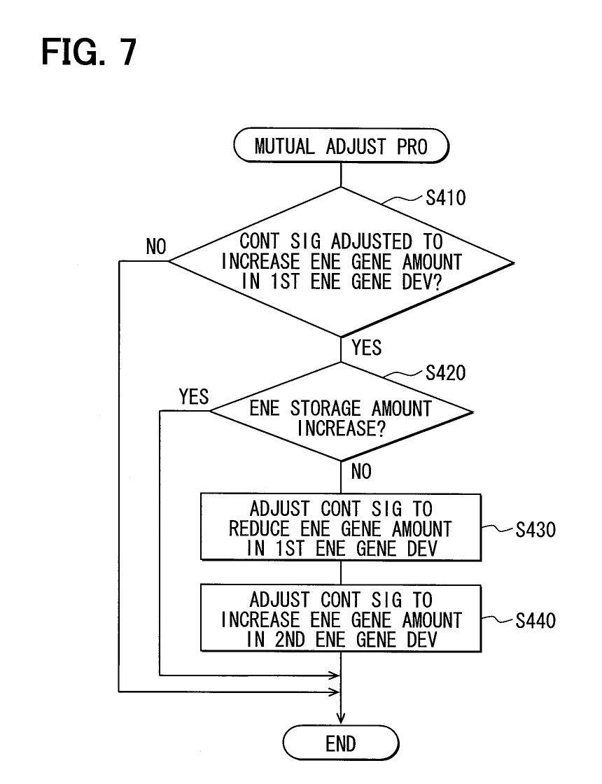

The computer 31 executes the mutual adjustment process in FIG. 7 at every predetermined time interval or every time the process in FIG. 4 is terminated.

As shown in FIG. 7, when the computer 31 starts to execute the mutual adjustment process, at step S410, the computer 31 determines whether the control signal to the first energy generating device is adjusted in order to increase the energy generating amount in the first energy generating device in step S240.

When the determination of step S410 is “NO,” the mutual adjustment process ends. When the determination in step S410 is “YES,” i.e., when the computer 31 adjusts the control signal to increase the energy generating amount in the first energy generating device, it goes to step S420.

In step S420, the computer 31 determines whether the energy storage amount in the first energy storage device increases. For example, when the first energy storage device is the battery 15, the computer 31 monitors the charge current of the battery 15 in a predetermined time interval, and the computer 31 determines whether the charge current increases more than a predetermined threshold value. When the first energy storage device is the cooling storage device 45, the computer 31 monitors the temperature of the regenerating agent 46 in a predetermined time interval, and the computer 31 determines whether the temperature of the agent 46 is reduced more than a predetermined threshold value.

When the computer 31 determines in step S420 that the energy storage amount increases, the computer 31 terminates the mutual adjustment process. When the computer 31 determines in step S420 that the energy storage amount does not increase, it goes to step S430.

In step S430, the computer 31 adjusts the control signal to the first energy generating device again in order to reduce the energy generating amount of the first energy generating device. Specifically, the computer 31 cancels the adjustment performed at step S240, and the computer 31 adjusts the control signal of the first energy generating device to return the control signal determined in step S120.

In step S440, the computer 31 adjusts the control signal to the second energy generating device in order to increase the energy generating amount of the second energy generating device. Then, the computer 31 ends the mutual adjustment process.

In the ECU 41 according to the second embodiment, since the computer 31 executes the mutual adjustment process, the fuel consumption ration for accumulating energy in the battery 15 and the cooling storage device 45 is improved.

For example, when the inner resistance increases because of the deterioration of the battery 15, so that the charge current to the battery 15 is limited, a saturation state may arise such that the charge amount to the battery 15 does not increase even when the control signal to the alternator 13 is adjusted in order to increase the generating amount at the alternator 13. In this case, the determination in step S420 is “NO.” In steps S430 and S440, although the generating amount at the alternator 13 is reduced, the cold energy generating amount at the compressor 43 increases. Thus, the storage cold energy amount in the cooling storage device 45 increases. Accordingly, a part of the output power of the engine 11 for charging the battery 15, which corresponds to the wasted energy of the saturation state, is used for storing the cold energy in the cooling storage device 45. Thus, the output power of the engine 11 is effectively utilized. The fuel amount for utilizing to accumulate the energy in the battery 15 and the cooling storage device 45 is reduced.

In step S220 in FIG. 4, the calculated difference Δ may be stored in the RAM. In the second embodiment, the cooling storage device 45 may be arranged on an upstream side of the evaporator 55.

In the second embodiment, two pairs of the energy generating device and the energy storage device are arranged. Alternatively, three or more pairs of the energy generating device and the energy storage device may be arranged.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An energy generation controller for a vehicle comprising:
an internal combustion engine of the vehicle;
an energy generating device driven by the internal combustion engine for converting a driving force of the internal combustion engine to a predetermined type of energy, an energy generating amount of the energy generating device being controlled by a control signal;
an energy storage device for storing a whole of or a part of the predetermined type of energy, which is generated at the energy generating device;
an output device for determining the control signal for generating a target energy amount of the energy generating device when the internal combustion engine is in a predetermined operating state, and for outputting the control signal to the energy generating device;
a detector for detecting an energy accumulation amount stored in the energy storage device;
a comparison device for comparing the energy accumulation amount detected by the detector with an assumption accumulation amount, which is estimated by the control signal determined by the output device; and
an adjustment device for adjusting the control signal to be output to the energy generating device according to a comparison result of the comparison device.

2. The energy generation controller according to claim 1, wherein the output device, the detector, the comparison device and the adjustment device perform operations with respect to each of a plurality of operating states of the internal combustion engine.

3. The energy generation controller according to claim 2, further comprising:
a memory for storing the comparison result of each operating state of the internal combustion engine.

4. The energy generation controller according to claim 1, further comprising:
an anomaly determination device, wherein:
the comparison device calculates a difference between the energy accumulation amount and the assumption accumulation amount; and
when the difference is not disposed in a predetermined allowance range, the anomaly determination device determines that an anomaly occurs.

5. The energy generation controller according to claim 1, further comprising:
a mutual adjustment device, wherein:
the energy generating device includes a first energy generating device and a second energy generating device;
the energy storage device includes a first energy storage device and a second energy storage device;
the output device includes a first output device and a second output device;
the detector includes a first detector and a second detector;
the comparison device includes a first comparison device and a second comparison device;
the adjustment device includes a first adjustment device and a second adjustment device;
the control signal includes: a first control signal corresponding to a first group including the first energy generating device, the first energy storage device, the first output device, the first detector, the first comparison device, and the first adjustment device; and a second control signal corresponding to a second group including the second energy generating device, the second energy storage device, the second output device, the second detector, the second comparison device and the second adjustment device; and
the mutual adjustment device adjusts the first control signal to be output to the first energy generating device in accordance with an adjustment result of the second control signal adjusted by the second adjustment device.

6. The energy generation controller according to claim 5, wherein:
when the second adjustment device adjusts the second control signal to increase the energy generating amount of the second energy generating device, and the mutual adjustment device determines that the energy accumulation amount detected by the second detector does not increase in proportion to an increase of the energy generating amount, the mutual adjustment device controls the second adjustment device to stop adjusting the second control signal, and the mutual adjustment device adjusts the first control signal to increase the energy generating amount of the first energy generating device.
